(19) United States
(12) Patent Application Publication
(10) Pub. No.: US 2013/0233289 A1
(43) Pub. Date: Sep. 12, 2013

(54) Supercharged Internal Combustion Engine

(71) Applicant: Udo Mailander, Bietigheim-Bissingen (DE)

(72) Inventor: Udo Mailander, Bietigheim-Bissingen (DE)

(21) Appl. No.: 13/482,905

(22) Filed: May 29, 2012

(30) Foreign Application Priority Data
May 30, 2011 (DE) 10 2011 102 817.3

(51) Int. Cl. F02B 33/00

(52) U.S. Cl. CPC F02B 33/00
USPC 123/562

(57) ABSTRACT

A supercharged internal combustion engine having a plurality of exhaust-driven superchargers staggered as a function of output of the engine, each connected or disconnected with a common exhaust manifold via an exhaust-driven turbine and an exhaust gas valve. Valve mechanisms are provided for changeover of transition air of an auxiliary compressor, having an output side connected to a common combustion air manifold, and of compressor air of a respective supercharger compressor added in staggered operation. Changeover is effected as a function of supercharger speed and combustion air pressure. Each valve mechanism has an ambient air valve, disposed between supercharger compressor outlet and combustion air manifold, and a supply air valve disposed between the compressor outlet and ambient air valve and leading to auxiliary compressor air inlet. A processor having a stored requirements profile activates/deactivates the exhaust gas valves, valve mechanisms and an auxiliary compressor motor.

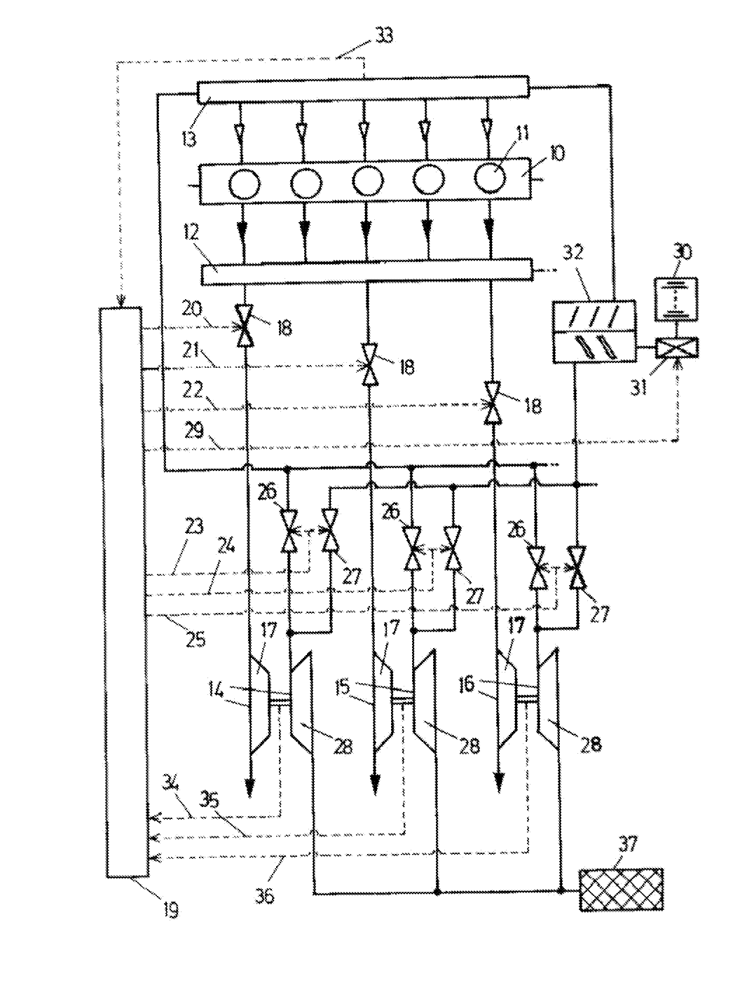

The instant application should be granted the priority date of May 30, 2011, the filing date of the corresponding German patent application 10 2011 102 817.3.

### BACKGROUND OF THE INVENTION

The present invention relates to supercharged internal combustion engine having a common exhaust manifold and a common combustion air manifold for all of the combustion chambers of the cylinders of the engine. The internal combustion engine also has a plurality of exhaust-driven superchargers that are staggered as a function of the output of the engine, wherein each of the superchargers, via an exhaust-driven turbine thereof and a respective exhaust gas valve, is configured to be connected or disconnected with the common exhaust manifold. The engine also has an auxiliary compressor that is driven by a separate motor, as well as valve mechanisms for a reversal or changeover of the transition air of the auxiliary compressor and the compressor air of the respective exhaust-driven supercharger that is added in staggered operation, with the changeover being effected as a function of the speed of the respective supercharger and of the combustion air operating pressure. The internal combustion engine is furthermore provided with a computer or processor having a stored requirements profile for activating or deactivating the exhaust gas valves, the valve mechanisms, and the motor of the auxiliary compressor.

With the aid of the supercharging, it is possible in a small internal combustion engine to realize the output of an otherwise considerably larger internal combustion engine. In the case of a prescribed rated output, the engine can be considerably smaller due to its supercharging. During the supercharging of internal combustion engines having exhaust-driven superchargers, there results the conflicting objectives that on the one hand due to the supercharging an increase of the rated output is possible, and on the other hand for this purpose the geometrical/mechanical compression must be proportionally reduced relative to the desired increase in rated output. Due to the reduction of the geometrical/mechanical compression, however, the output or torque of the supercharged internal combustion engine drops in an over-proportional manner in the lower speed range, which is attributable to the operating speed plot of the output curve, which for exhaust-driven superchargers is very steep. A fluid-producing mechanism can bring about an optimal flow, and hence a high output, only within a very narrow speed range. This is the opposite of the desire in internal combustion engines of land vehicles for the production of a propulsion hyperbola. However, by the use of a plurality of exhaust-driven superchargers, not only the operating speed range of the internal combustion engine, but also the special volumetric operating size of the exhaust-driven superchargers, can be divided. However, the resulting, chronologically offset engagement of the superchargers easily leads the supercharging system into the range of the pumping and to the collapse of the combustion air flow in the compressor that is to be engaged if, for example, the air, which initially flows from the second compressor at very low pressure via a discharge valve into the atmosphere, is intended to pass into the combustion air manifold of the internal combustion engine that is already under the full pressure of the first compressor, in other words, from a flow-producing mechanism having a relatively high flow velocity and little possibility for building up pressure to a reciprocating engine having a relatively low flow velocity and a relatively high possibility for building up pressure.

Mechanical positive-displacement chargers, which can be driven by the internal combustion engine itself or by a separate motor, easily convey the air required for idling of the internal combustion engine, but in the high output/high speed range of the internal combustion engine cannot compete with an exhaust-driven supercharger. Therefore, it is customary on an internal combustion engine to combine the respective advantages of an exhaust-driven supercharger and a positive-displacement compressor by a series connection or a parallel connection of the two chargers. This is particularly applicable for counteracting the so-called turbo hole or leak, which results when upon start-up of the internal combustion engine, a single or first exhaust-driven supercharger comes only slowly up to speed due to the slowly increasing generation of exhaust gas.

A supercharged internal combustion engine of the aforementioned general type is known from U.S. Pat. No. 6,966,183 B2, and in conjunction with an increase in output, an improved acceleration performance in the start-up range, and a transition harmonic operating spectrum from very low speed at partial throttle and full throttle up to high speed at partial throttle and full throttle, enables a staggered activation and deactivation of exhaust-driven superchargers without the aforementioned pump effect. All of the exhaust-driven superchargers, at the input side of their compressors, have a line connection to the outlet of the common auxiliary compressor, as a result of which the auxiliary compressor, which has a smaller output, is generally disposed in series upstream of the respective exhaust-driven supercharger. However, this limits the reduction in size of the mechanical charger, because in terms of time it must be joined in counter to the subsequent flow machine. The valve arrangement of each exhaust-driven supercharger that is on the side of the combustion air is disposed at the inlet of the compressor, and is comprised of an ambient air valve and a supply valve that leads to the auxiliary compressor. Complicated regulating valves are required for the oppositely directed changeover of these two valves.

It is an object of the present invention, for a supercharged internal combustion engine of the aforementioned general type, to reduce the capital outlay for the auxiliary compressor and the valve mechanisms on the compression air side, to simplify the switching cycle of the valve mechanisms, and to more greatly stabilize the combustion air pressure of the internal combustion engine.

### BRIEF DESCRIPTION OF THE DRAWINGS

This object, and other objects and advantages of the present invention, will appear more clearly from the following specification in conjunction with the single schematic drawing, which is a block diagram illustrating one exemplary embodiment of the supercharged internal combustion engine of the present application.

### SUMMARY OF THE INVENTION

The object of the present invention is realized for a supercharged internal combustion engine in that each valve mechanism is comprised of an ambient or main air valve and a supply or auxiliary air valve, wherein the ambient air valve is disposed between the combustion air outlet of the compressor of the exhaust-driven supercharger and the combustion air manifold, and the supply air valve is disposed between the combustion air outlet of the compressor and the ambient air valve, with the supply air valve leading to the air inlet of the auxiliary compressor; the output side of the auxiliary compressor is connected to the combustion air manifold.

By placing the auxiliary compressor between the compressors of the exhaust-driven superchargers and the combustion air manifold, ambient air is temporarily drawn through the respective compressors, so that despite the serial arrangement of the auxiliary compressor, the effect is a parallel connection thereof with each exhaust-driven supercharger that is in operation. The exhausting of the respective compressor there encounters an extremely low resistance to flow, and facilitates the start-up of this compressor upon opening of the pertaining exhaust gas valve. The auxiliary compressor, without any problem, overcomes any counter pressure from the other combustion air sources, whereas the exhaust-driven superchargers operate optimally only in a narrow speed range. With regard to the valve mechanisms, which each comprise an ambient air valve and a supply air valve, there is achieved the advantage that simple switching valves instead of complicated regulating valves can be utilized. The computer or processor is preferably configured for a signal delivery for the abrupt connection or disconnection of the auxiliary compressor, which is driven by an electric motor, and of the switching valves, whereby within the objective different switching signals can be merged in groups.

The auxiliary compressor is no longer used only for counteracting the so-called turbo leak during start-up of the internal combustion engine, and for the combination of the advantages of a positive-displacement charger with those of a flow charger, but rather also to ensure the forward flow in each of the exhaust-driven superchargers, which are to be additionally connected in a chronologically offset manner. in particular with a fine division of the operating spectrum of the internal combustion engine by means of numerous exhaust-driven superchargers, one can get by not only with a small overall size of the superchargers, but at the same time with a particularly small auxiliary compressor. As a separate motor of the auxiliary compressor, an electric motor can be used that derives its drive energy from an electrical vehicle battery. Such a motor reacts and starts more rapidly than does a separate internal combustion engine or a gear linkage to the main motor that is to be supercharged. In addition, due to the division of the operating spectrum of the internal combustion engine via the superchargers during the operation of a motor vehicle, one can eliminate a number of gear change steps, in that the sequence of the exhaust-driven superchargers in their staggered placement into operation can be easily changed with regard to a uniform wear, and in that a disruption in one of the superchargers can be bypassed by a pre-programmed factoring thereof.

Further specific features of the present invention will be described in detail subsequently.

### DESCRIPTION OF SPECIFIC EMBODIMENTS

Referring now to the drawings in detail, shown as an internal combustion engine 10 is a five-cylinder engine in order to indicate that with the supercharging arrangement there is no conceptual limitation on the number of the cylinders 11 that are to be supplied with combustion air. The dotted line extensions on both the exhaust manifold 12 of the internal combustion engine 10 and on the charge or combustion air manifold 13 of the engine 10 are intended to indicate that in addition to the three symbolically indicated exhaust-driven superchargers 14, 15, and 16, a number of further superchargers that are activatable and deactivatable in a staggered manner can also be provided for dividing the operating spectrum of the internal combustion engine 10. In practice, one would generally limit oneself to six to ten identical superchargers, which represent a compromise between the fineness of the division of the operating spectrum of the internal combination engine 10 and the capital outlay for the supercharging arrangement of the engine 10.

The combustion air flows to the cylinders 11 of the internal combustion engine 10 are indicated by light arrowheads and the exhaust gas flows are indicated by dark arrowheads. Disposed between the exhaust manifold 12 of the internal combustion engine 10 and the exhaust-driven turbine 17 of each exhaust-driven supercharger 14, 15, 16, etc., is an exhaust gas valve 18 which is individually controllable by the computer or similar processor 19, which is provided with a stored requirements profile. In the drawing, the pertaining control lines 20, 21 and 22 are indicated by dashed lines. Further control lines 23, 24 and 25 of the computer 19 lead to the valve mechanisms at the air outlet of the compressor 28 of the exhaust-driven superchargers 14, 15 and 16, which valve mechanisms include an ambient or main air valve 26 and a supply or auxiliary air valve 27. Yet another control line 29 connects the computer 19 with the relatively small electric motor 31 of the auxiliary compressor 32, which at the input side is connected to all of the supply valves 27, and at the output side is connected with the combustion air manifold 13; the electric motor 31 derives its drive energy from an electric vehicle battery 30. The computer 19, which is provided with a stored requirements profile, receives pressure signals from the combustion air manifold 13 via the 15 signal line 33, and receives speed signals from the superchargers 14, 15 and 16 via the signal lines 34, 35 and 36, whereby on the charge or combustion air side, a common air filter 37 is disposed upstream of the exhaust-driven superchargers.

Due to the fact that all of the ambient air valves 26, supply air valves 27, and exhaust gas valves 18 are configured to be selected from a positively closed position, the supply of combustion air to the turbocharged internal combustion engine 10 is further simplified. To reduce the capital outlay, the ambient air valves 26 and the supply air valves 27 are embodied as switching valves and thus not as regulating valves. In order to increase the reaction speed in the change of the combustion air requirement of the internal combustion engine 10, and to relieve the computer 19, when one of the exhaust-driven superchargers 14, 15, 16, etc. is additionally activated, controlled by the computer 19, the start signal of the auxiliary compressor 32 is merged with the opening signal of the exhaust gas valve 18 of the pertaining supercharger, and the deactivation signal of the auxiliary compressor 32 is merged with the closing signal of the supply valve 27 and with the opening signal of the ambient air valve 26 of this supercharger. Similarly, when one of the exhaust-driven superchargers 14, 15, 16, etc. is deactivated, controlled by the computer 19, the start signal of the auxiliary compressor 32 is merged with the opening signal of the supply air valve 27 and with the closing signal of the supply air valve 27 and with the closing signal of the ambient air valve 26 of the pertaining supercharger, and the deactivation signal of the auxiliary compressor 32 is merged with the closing signal of the supply air valve 27 and with the closing signal of the exhaust gas valve 18 of this exhaust-driven supercharger.

The electric motor 31, which can be activated and deactivated via the control line 29 by the computer 19, is always activated only briefly, until a reverse or backward flowing of charge or combustion air is precluded via the respectively additionally activated exhaust-driven supercharger. In the pauses of operation of the auxiliary compressor 32 during the operation of the internal combustion engine 10, the vehicle battery 20 can easily be recharged by a generator connected to the internal combustion engine 10. In addition, in the meantime very high power vehicle batteries 30 are available, so that even with very large internal combustion engines 10, the start-up weakness of an exhaust-driven supercharger 14, 15 or 16 that is to be additionally activated can be compensated for extremely quickly by means of the auxiliary compressor 32.

The operation of the auxiliary compressor 32 via the computer 19 upon acceleration of the internal combustion engine 10 is preferably limited to a starting range of that respectively pertaining one exhaust-driven supercharger 14, 15, 16, etc. in the sequence of all of the exhaust-driven supercharges that are inserted in a staggered manner. This protects the auxiliary compressor 32 and relieves the electrical vehicle battery 30. To stabilize the constant pressure aspired to in the combustion air manifold 13 by reducing abrupt deactivation processes, during deceleration of the internal combustion engine the operation of the auxiliary compressor 32 is additionally limited via the computer 19 to a respectively pertaining one of the exhaust-driven superchargers 14, 15, 16, etc. in the switching sequence of all of the exhaust-driven supercharges that are inserted in a staggered manner.

The advantages of the described supercharging arrangement are particularly evident if the internal combustion engine 10 is embodied as a diesel engine having a compression that is greatly reduced to about 8:1. The internal combustion engine 10 itself can then be enormously reduced while being able to deliver the same power. The numerous exhaust-driven superchargers 14, 15, 16, etc. easily furnish the relatively high deficient load capacity, whereby the auxiliary compressor 32, which in an expanded function is employed as a charge or combustion air support, can also be considerably reduced in size. The reduction in size of the auxiliary compressor 32 is for all that based not only upon the plurality of exhaust-driven superchargers and its brief operation, but also on the fact that it draws in its air from a turbo engine and does not have to operate thereagainst.

The specification incorporates by reference the disclosure of German priority document 10 2011 102 817.3 filed May 30, 2011.

The present invention is, of course, in no way restricted to the specific disclosure of the specification and drawings, but also encompasses any modifications within the scope of the appended claims.

What I claim is:

1. A supercharged internal combustion engine, comprising:
a common exhaust manifold and a common combustion air manifold for all combustion chambers of cylinders of said internal combustion engine;
a plurality of exhaust-driven superchargers that are staggered as a function of the output of said internal combustion engine, wherein each of said exhaust-driven superchargers has an exhaust-driven turbine, and wherein each of said exhaust-driven superchargers, via said exhaust-driven turbine and a respective exhaust gas valve, is configured to be connected or disconnected with said common exhaust manifold;
an auxiliary compressor, wherein an output side of said auxiliary compressor is connected to said common combustion air manifold;
a separate motor for driving said auxiliary compressor;
valve mechanisms for a changeover of transition air of said auxiliary compressor and of compressor air of a compressor of the respective exhaust-driven supercharger that is added in staggered operation, wherein said changeover is effected as a function of the speed of said respective exhaust-driven supercharger and a combustion air operating pressure, further wherein each of said valve mechanisms is comprised of an ambient air valve and a supply air valve, further wherein said ambient air valve is disposed between a combustion air outlet of said compressor of said respective exhaust-driven supercharger, and said common combustion air manifold, and wherein said supply air valve is disposed in a line that branches off between said combustion air outlet of said compressor and said ambient air valve, and that leads to the air inlet of said auxiliary air compressor; and
a processor having a stored requirements profile for activation or deactivation of said exhaust gas valves, said valve mechanisms, and said separate motor of said auxiliary compressor.

2. An internal combustion engine according to claim 1, wherein all of said ambient air valves, said supply air valves, and said exhaust gas valves are configured to be selectable from a positive closed position.

3. An internal combustion engine according to claim 1, wherein said ambient air valves and said supply valves are embodied as switching valves and are not regulating valves.

4. An internal combustion engine according to claim 1, wherein upon additional activation of one of said exhaust-driven superchargers, controlled by said processor, an activation signal of said auxiliary compressor is merged with an opening signal of said supply air valve, and with an opening signal of said exhaust gas valve of said one exhaust-driven supercharger, and wherein a deactivation of said auxiliary compressor is merged with a closing signal of said supply air valve, and with an opening signal of said ambient air valve of said one exhaust-driven supercharger.

5. An internal combustion engine according to claim 4, wherein upon deactivation of one of said exhaust-driven superchargers, controlled by said processor, an activation signal of said auxiliary compressor is merged with an opening signal of said supply air valve and with a closing signal of said ambient air valve of said one exhaust-driven supercharger, and wherein a deactivation signal of said auxiliary compressor is merged with a closing signal of said supply air valve, and with a closing signal of said exhaust gas valve of said one exhaust-driven supercharger.
